(19) United States
(12) Patent Application Publication
(10) Pub. No.: US 2024/0143404 A1
(43) Pub. Date: May 2, 2024

(54) WORKLOAD DEPLOYMENT AUTOMATION IN CLOUD COMPUTING ENVIRONMENTS

(71) Applicant: State Farm Mutual Automobile Insurance Company, Bloomington, IL (US)

(72) Inventor: Daniel Enomoto, Normal, IL (US)

(21) Appl. No.: 18/384,550

(22) Filed: Oct. 27, 2023

Related U.S. Application Data
(60) Provisional application No. 63/419,989, filed on Oct. 27, 2022.

(51) Int. Cl. G06F 9/50

(52) U.S. Cl. CPC G06F 9/5038; G06F 9/5072

(57) ABSTRACT

Techniques described herein relate to modifying and deploying workloads across cloud computing environments. Workloads such as a contact flow executing in contact center computing environment may interact with various other objects and resources in the computing environment, such as queues, flows, prompts, etc. Contact flows may be developed and tested in source computing environments and then deployed to one or more production environments. In various examples described herein, an automation pipeline may determine a number of objects in a source computing environment referenced by the workload, determine the corresponding objects in the destination computing environment, and determine and replace the unique identifiers associated with the referenced objects to allow the workload to be deployed in the destination environment. Additional techniques described herein include user access verification within both source and destination environments to further automate the integration and deployment processes for the workload.

### CROSS-REFERENCE TO RELATED APPLICATIONS

This application claims priority to and is a non-provisional of U.S. Patent Application No. 63/419,989, filed Oct. 27, 2022, and entitled “WORKLOAD DEPLOYMENT AUTOMATION IN CLOUD COMPUTING ENVIRONMENTS,” the disclosure of which is incorporated by reference herein in its entirety for all purposes.

### BACKGROUND

An organization may use cloud computing environments for implementing software solutions for the organization, to provide improved flexibility, scalability, and access to a wide range of cloud services. Such cloud-based software deployments may be used instead of, or in addition to, software deployed within on-premise computing infrastructures (e.g., datacenters) of the organization. To deploy and manage software solutions within cloud computing environments, a cloud provider may provide cloud-based services and/or other computing resources via remote cloud servers, including computing infrastructure applications, network functionality, and data resources. Cloud services may include Software-as-a-Service (SaaS), Infrastructure-as-a-Service (IaaS), and Platform-as-as-Service (PaaS), which may be delivered via public, private, and/or hybrid cloud implementations. In addition to the increased flexibility and scalability and cloud environments, cloud services also may provide customer organizations with increased security, system reliability, seamless provisioning and updates, as well as lower costs for software licenses, computer hardware infrastructures, and maintenance personnel.

However, building, deploying, and configuring cloud computing environments often includes time-consuming and labor-intensive technical processes. For example, to create and deploy a cloud-based environment, a cloud deployment engineer or other user within the organization may initially create an account at the cloud service provider which will host the cloud environment. The operator may then perform processes to attach the environment to the organization, create a name for the environment, and set access permissions, aliases and contact information associated with the environment. The operator also may define the set of network constructs for the environment, create and define roles associated with the account, implement logging capabilities, encryption, and/or any additional organization-specific controls or automated processes required for the cloud environment. Each of these steps may include manual operations that must be performed by engineers and/or other operators of the organization with sufficient technical expertise and organizational experience. These steps also must be initiated, completed, and verified in a preestablished order to successfully deploy the environment within the cloud.

Further, to develop and deploy software solutions as workloads within such environments, organizations may create and provision multiple separate computing environments and/or accounts within one or more cloud service providers. A large organization, for example, may build and deploy hundreds or thousands of cloud environments (and/or on-premise environments) having similar or identical computing infrastructures and/or configurations. Within such an organization, different product development teams may use separate cloud deployments so that each team can work independently and make updates to specific components without affecting the components controlled by other development teams. Additionally, organizations may generate separate deployments for different types/functions of environments, such as different deployments for research environments, test environments, and production environments. Such environments may require a set of commonly provisioned and configured cloud components, but also may require separate network constructs, services, and automation that enforce different security protocols, logging capabilities, etc. Further, when the policies or personnel of the organization change, certain changes may require time-consuming manual updates to each of the accounts and deployed environments created by the organization.

### SUMMARY

To address these and other problems and inefficiencies, this disclosure describes systems and techniques for modifying and deploying software solutions implemented as workloads across cloud computing environments. Workloads may include any combination of software objects, including services, applications, and/or other computing resources, configured for deployment in a cloud computing environment. For instance, in a contact center computing environment, contact flows may be software objects that define the customer experience for customers accessing the contact center via voice services, video services, chat services, etc. An organization may design and deploy a contact flow to customize the user experiences of its customers, define menu options, and route customers to particular agents based on various criteria and intelligence. Like other software workloads that may be deployed in cloud environments, contact flows may include a number of independent software components that also interact with various software objects and/or services within the cloud environment. For instance, a contact flow deployed within a cloud-based contact center computing environment may interact with any number of queues, flows, prompts, etc.

In various examples described herein, a contact flow (or other cloud-based workloads) may be developed and tested in a source computing environment, and then may be deployed to one or more production environments for use by customers. As described herein, an automation pipeline (and/or other workload deployment system) may receive a request to deploy a contact flow (or other workloads) from a source (e.g., test) environment to a destination (e.g., production) environment, and may determine the objects within the source environment that are referenced by the workload. The automation pipeline then may determine the corresponding objects within the destination computing environments, and may determine and replace the unique identifiers for the referenced objects, thereby allowing the workload to be deployed seamlessly in the destination environment. Additional techniques described herein include performing user access verification via the automation pipeline, within both the source and destination computing environments, to further automate the integration and deployment processes for the workload.

In an example of the present disclosure, a method includes a number of operations performed by a deployment automation pipeline, including receiving, by the deployment automation pipeline, data identifying a contact center workload deployed within a first cloud computing environment. In this example, the contact center workload may include a plurality of unique identifiers associated with a plurality of objects in the first cloud computing environment. The deployment automation pipeline may determine, based on a first unique identifier in the contact center workload, a first object in the first cloud computing environment. Additionally, the deployment automation pipeline may determine a first object name associated with the first object, for example, by matching the first unique identifier within a first object listing of the first cloud computing environment. In this example, the deployment automation pipeline may determine a second unique identifier associated with a second object in a second cloud computing environment, including matching the first object name within a second object listing of the second cloud computing environment. Further, the deployment automation pipeline may modify the contact center workload for deployment within the second cloud computing environment, wherein modifying the contact center workload includes replacing instance(s) of the first unique identifier with the second unique identifier in the contact center workload.

In another example of the present disclosure, a computer system comprises one or more processors, and one or more non-transitory computer-readable media storing computer-executable instructions that, when executed by the one or more processors, cause the one or more processors to perform various operations. The operations in this example include receiving a workload deployment request identifying a contact center workload deployed within a source cloud computing environment, and determining a destination cloud computing environment associated with the workload deployment request. In this example, the operations also may include determining a first unique identifier in the contact center workload, and determining a first object name associated with the first unique identifier, wherein determining the first object name includes matching the first unique identifier within a first object listing of the source cloud computing environment. Further, in this example, the operations performed by the computer system may include determining a second unique identifier in the destination cloud computing environment, including by matching the first object name within a second object listing of the destination cloud computing environment, and modifying the contact center workload for deployment within the destination cloud computing environment, for example, by replacing instance(s) of the first unique identifier with the second unique identifier in the contact center workload.

Another example of the present disclosure includes one or more non-transitory computer-readable media storing instructions executable by a processor, wherein the instructions, when executed, cause the processor to perform various operations. The operations in this example include receiving data identifying a contact center workload deployed within a source cloud computing environment, and determining a destination cloud computing environment for the contact center workload. Additionally, the operations in this example may include determining a first unique identifier in the contact center workload, associated with a first object deployed in the source cloud computing environment, and determining a first object name associated with the first unique identifier, which can include matching the first unique identifier within a first object listing of the source cloud computing environment. The operations in this example also may include determining a second unique identifier associated with a second object in the destination cloud computing environment, which may include matching the first object name within a second object listing of the second cloud computing environment, and modifying the contact center workload by replacing instance(s) of the first unique identifier with the second unique identifier in the contact center workload.

### BRIEF DESCRIPTION OF THE DRAWINGS

FIG. 1 depicts an example computing environment including a workload deployment system configured to deploy contact center workloads between different cloud-based environments, in accordance with one or more examples of the present disclosure.

FIG. 2 depicts an example computing environment including a workload deployment system on a number of separate cloud computing environments, in accordance with one or more examples of the present disclosure.

FIG. 3 depicts an example contact flow object that may be deployed within a computing environment, in accordance with one or more examples of the present disclosure.

FIG. 4 depicts an example technique for performing user access verification on source and destination computing environments in response to a deployment request received by a workload deployment system, in accordance with one or more examples of the present disclosure.

FIGS. 5A and 5B depict an example technique for modifying and deploying a workload within one or more destination computing environments in response to a deployment request received by a workload deployment system, in accordance with one or more examples of the present disclosure.

FIG. 6 depicts an example technique for deploying a modified workload within a destination computing environments, in response to a deployment request received by a workload deployment system, in accordance with one or more examples of the present disclosure.

FIG. 7 is an example architecture of a computer server capable of executing program components for implementing various techniques described herein.

### DETAILED DESCRIPTION

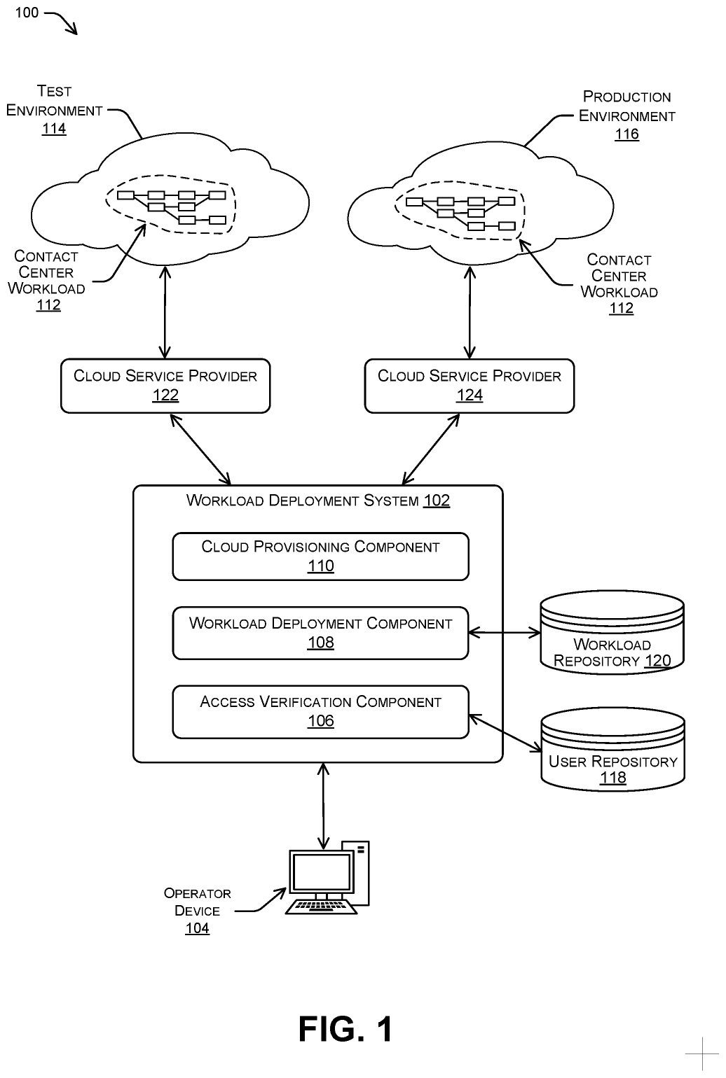

FIG. 1 illustrates an example computing system 100 for modifying and deploying workloads across cloud-based computing environments. In this example, a workload deployment system 102 may be configured to receive requests from an operator device 104 to deploy workloads (e.g., contact flows) in computing environments (e.g., contact center deployment environments). For instance, a deployment engineer (or other authorized operator) associated with an organization may access the workload deployment system 102 to perform software deployments from one or more source computing environments of the organization, to one or more destination computing environments. In this example, the workload deployment system 102 includes an access verification component 106, a workload deployment component 108, and a cloud provisioning component 110. The components of the workload deployment system 102, described in more detail below, may allow the deployment engineer to deploy a workload 112 that has been developed and tested in a test computing environment 114, onto a production computing environment 116 for use by customers of the organization.

In various examples described herein, the workload deployment system 102 may be implemented as an automation pipeline configured to receive requests from operation device(s) 104 and to automatically deploy workloads, such as contact flows and/or other contact center software workloads, from source computing environments to destination computing environments. In these examples, each source and/or destination environment may operate separately and independently, and each may include a separate set of software objects (e.g., services, applications, datastores, etc.) and/or other computing resources associated with the computing environment. The separate computing environments, which may include public or private cloud computing environments, hybrid cloud environments, and/or on-premise computing infrastructures, also may include separate object listings with separate sets of unique identifiers for the software objects and other computing resources of the computing environment. Additionally, different computing environments also may store and manage separate user authorization data for their respective environments. Therefore, different computing environments, even those associated with the same organization, may have different sets of authorized users and/or user credentials, and/or may store different unique user identifiers even for the same user.

As a result of the differences between computing environments, before a software workload can be deployed from a source environment to a destination environment, the workload deployment system 102 may be required to modify the workload for compatibility with the destination environment. For example, any references within the workload to additional objects in the source environment that the workload interacts with during execution, may be modified to the corresponding objects in the destination environment. For instance, workloads such as contact flows in a contact center deployment environment may interact with other objects in the deployment environment, including but not limited to queues, prompts, other flows, chat bots, etc. For a contact center workload 112 (e.g., a contact flow) to be deployed from a test environment 114 to a production environment 116, each object identifier in the contact flow referencing another object or resource in the test environment 114 may be required to be changed to the object identifier of a corresponding object in the production environment. Similar examples may apply not only to contact flows and other workloads deployed in contact center environments, but to any workload including various software services, applications, components, etc. that may be deployed across computing environments.

Certain existing techniques modifying workloads for deployment into production computing environments may involve manual identification of the object identifiers of the source environment to be replaced, as well as manual identification and/or replacement of the identifiers with the identifiers of the corresponding objects in the destination environment. However, such techniques may be both time-consuming and error-prone, resulting in deployment delays and a greater potential for deployment failures. Additional techniques for modifying workloads for deployment can involve the use of complex databases to map object associations across different computing environments. However, such databases can be cumbersome to generate and confusing to update, and may involve dual management responsibilities by the organization as well as the cloud environment provider. Updates to such databases are also performed manually, making the databases equally susceptible to human error which can cause deployment failures. Finally, databases configured to map object associations across computing environments might only be feasible for certain types of related computing environments, such as for multiple accounts of an organization at the same cloud service provider, and may be infeasible for managing object mappings across different cloud providers, object mappings between cloud and on-premise infrastructures, etc.

In contrast to these and other existing solutions, the techniques described herein include modifying workloads for deployment into new computing environments by matching the names of objects between the source and destination environments (e.g., test and production environments) and using the object name matching to determine replacements for the unique identifiers within the workload. For example, responsive to a workload deployment request, the workload deployment system 102 may determine a number of objects within the source computing environment with which the workload interacts. The workload deployment system 102 then may use object name matching and/or related techniques to determine corresponding objects in the destination environment(s) for each referenced object in the source environment. The workload deployment system 102 may retrieve the unique identifiers within the destination environment for the corresponding objects, and use the unique identifiers to replace the corresponding identifiers of the source objects in the workload. Finally, the modified workload may be deployed automatically and seamlessly to the destination environment, without requiring manual modification of the workload or managing complex databases to store object associations across the computing environments.

Initially, the workload deployment system 102 may receive a workload deployment request from an operator device 104. The workload deployment request may identify the workload to be modified and deployed, the source computing environment in which the workload currently resides, and/or the destination computing environment into which the workload is to be deployed. For example, a request from the operator device 104 may identify the contact center workload 112 (e.g., a contact flow) within the test environment 114, and also may identify the production environment 116 into which the workload 112 is to be deployed.

As noted above, the operator device 104 may be controlled by a deployment engineer or other authorized operator associated with the organization. The operator device 104 may be implemented using, for example, a desktop or laptop computer, tablet computer, mobile device, or any other computing device. The operator device 104 may include network interfaces and functionality capable of accessing the workload deployment system 102, and client software configured to access the interface(s) provided by the workload deployment system 102.

The workload deployment system 102 and its various components may be implemented, individually or in combination, using various different computing architectures, such as computing devices, servers, and/or other computing systems. As shown in this example, the workload deployment system 102 may be implemented in a separate computing system or infrastructure that is external to the computing environments in which the deployments are executed, such as a secure on-premise computing system. However, in other examples, the workload deployment system 102 may be implemented within one or more of the source and/or destination computing environments described herein. The various source and destination computing environments described herein may include, but are not limited to, public or private cloud environments, hybrid cloud environments, and/or on-premise computing infrastructures.

In some examples, the operator device 104 may execute a thin, web-based client (e.g., Internet browser) to access an interface of the workload deployment system 102 via a secure network. Additionally or alternatively, the workload deployment system 102 may include a thick client in which some or all of the interface functionality may execute on the operator device 104. In various examples, the workload deployment system 102 may be configured to provide one or more graphical user interfaces (GUIs), such as web browser-based or application-based interfaces through which a deployment engineer (or other authorized individual) may access the system to perform deployments of workloads in an organization into new computing environments. Examples of GUIs that may be provided by the workload deployment system 102 are described below, for instance, in response to the system determining an on-the-fly determination by the system that one or more object names within the source environment cannot be matched to objects within the destination environment(s) with sufficient confidence. In other examples, GUIs need not be implemented and the workload deployment system 102 may include only one or more programmatic interfaces (e.g., APIs) or other non-graphical interfaces.

When the workload deployment system 102 receives a workload deployment request from an operator device 104, as noted above, the request may identify the workload within a source environment (e.g., a test environment), and the destination environment(s) (e.g., production environments) into which the workload is to be deployed. In some examples, workload deployment requests received from the operator device also may include data identifying the configuration variables associated with a configuration (and/or any other attribute) that can be used for deployment. For instance, configuration variables may include any selection made by an operator or any input provided during the configuration and/or deployment of a workload into a cloud-based environment (or non-cloud-based computing infrastructure such as datacenter). Examples of configuration variables may include, but are not limited to, account names and/or aliases associated with the environment, the organizations and/or projects associated with the environment, and contact information associated with the environment (e.g., administrator(s), email addresses, etc.). Additional examples of configuration variables may include the type/functionality of the environment (e.g., production or non-production, active or inactive, etc.), and roles associated with the account (e.g., identification of administrators, product developers, etc.). Additional configuration variables may include the specifications for network constructs to be used in the environment, such as the IP addresses and/or configuration data of the virtual private network, routing tables, routing rules, security policies/groups, network access controllers, and/or transit gateway associated with the environment. Additional examples of configuration variables may include data identifying the cloud service provider and/or cloud region for the environment, the continuous integration and continuous deployment (CI/CD) pipeline associated with the environment, the encryption component(s) to be used within the environment, the logging component(s) to be used, and/or any other automation components tools, or services to be used in the environment. It can be understood from the context of this disclosure that the examples of configuration variables described herein are illustrative and non-limiting, and that any attribute of a cloud-based deployment and/or cloud-based computing environment may be represented as configuration variables in some examples.

In response to receiving a workload deployment request, the workload deployment system 102 initially may verify that the requesting user/entity is authorized to perform the deployment. As described below in more detail, the workload deployment system 102 may include an access verification component 106 configured to determine a user (or other entity) associated with the workload deployment request, and then to verify that the user (or other entity) is authorized both to access the source environment of the workload (e.g., test environment 114), and is authorized to modify and/or deploy the workload within the destination environment(s) (e.g., production environment 116). In some examples, the workload deployment system 102 may authenticate the user of the operator device 104 to determine the user's identity, and may use the user identity to verify access within the source and destination environments. In such examples, the workload deployment system 102 may use various authentication techniques (e.g., password authentication, biometric authentication, token authentication, two-factor authentication, etc.). Additionally or alternatively, the workload deployment system 102 may verify the identity of the user submitting the request and/or credential of the user, based on the operator device 104 and/or the access network from which the operator device 104 is communicating with the workload deployment system 102 (e.g., IP address, access network, GUID, etc.).

After determining the user identity (and/or user credentials) associated with the workload deployment request, the access verification component 106 may verify that the user (and/or the device, network, etc.) is verified to access the workload 112 and associated objects within the source environment, and to modify/deploy the workload 112 within the destination environment. In some examples, the access verification component 106 may transmit requests to each of the source and destination computing environments, to verify that the user is authorized to perform the required operations within each of the computing environments. Such requests may include invoking APIs provided by the computing environments 114-116 and/or by the cloud service providers 122 to verify user authorization. In other instances, the access verification component 106 may access user lists maintained within the computing environments 114-116 to verify sufficient user authorization.

As shown in this example, the access verification component 106 may use a separate user data repository 118, external to the computing environments 114-116, to perform some or all of the user access verification. In this example, user data repository 118 may be associated with the workload deployment system 102 (e.g., implemented either within or external to the workload deployment system 102) but may be separate from any cloud-based computing environments associated with the workload deployment system 102. For instance, the user data repository 118 may store tables associating users of the organization with the various cloud providers, cloud accounts, aliases, and/or deployments maintained by the organization. The user data repository 118 may include specific access credentials for each organization user, role, department, etc., to access and modify each workload/deployment of the organization in the various cloud computing environments in which those workloads are deployed. In some examples, the access verification component 106 may use the user data repository 118 to verify the user authorization for a workload deployment request without needing to access any cloud-based or other remote source and/or destination computing environments. In other examples, the user data repository 118 may be optional and the access verification component 106 may verify access based on requests to the cloud providers and/or computing environments 114-116, or the access verification component 106 may use a combination of the user data in the user data repository 118 and additional requests to the computing environments 114 and 116 to verify access for the request.

By using the access verification component 106 to initially verify that sufficient access credentials exist within both the source and destination computing environments, the workload deployment system 102 may potentially save time and computing resources, as well as preventing deployment breaks when performing workload deployments and upgrades. For instance, when the access verification component 106 determines that the user or request is authorized to access the source environment but not the destination environment, or is authorized to access one destination environment (e.g., inactive production) but not another destination environment (e.g., active production), then the access verification component 106 may immediately reject the request and terminate the operation before any portion of the deployment has been performed. Additionally or alternatively, when sufficient access credentials do not exist on all of the necessary source and destination computing environments for the deployment, the access verification component 106 may initiate a user interface on the operator device 104 to request additional authorization credentials from the user. In other examples, the access verification component 106 may transmit a notification or separate communication to a different operator device (e.g., a deployment admin system) to request approval for the deployment and/or to request that the credentials for the user of the operator device 104 be elevated to allow the user to perform the deployment.

To deploy the workload from the source environment to the destination environment(s), the workload deployment system 102 may include a workload deployment component 108 configured to determine corresponding sets of objects in the source and destination environments with which the workload interacts, and to replace the unique identifiers for the objects to allow the workload to be deployed seamlessly in the destination environments. As shown in this example, the workload deployment component 108 initially may determine the set of objects and/or resources in the test environment 114 that are referenced (and/or interacted with) by the contact center workload 112 while it is deployed in the test environment 114. For instance, the contact center workload 112, which may be a contact flow or any other type of contact center cloud-based software deployment, may include unique identifiers for any various other objects/resources with which the workload interacts in the test environment 114, including but not limited to queues, prompts, additional flows, chat bots, etc. Each of these additional objects with which the contact center workload 112 interacts may be referenced within the code and/or data structures of the workload using unique identifiers that are specific to the test environment 114.

For each of the objects and/or resources in the test environment 114 referenced by or otherwise included in the contact center workload 112, the workload deployment component 108 may determine a corresponding object and/or resource in the production environment 116. In some examples, the workload deployment component 108 may use object name matching between the test environment 114 and the production environment 116 to determine the corresponding objects/resources. For instance, for each unique identifier in the contact center workload 112, the workload deployment component 108 may access an object listing for the test environment 114 (e.g., via an API or querying an object list table) to determine the object name assigned to the object. In some cases, the object names may be human-readable names for objects assigned by the developer or other user in the organization, whereas the unique identifiers may be machine-generated alphanumeric identifiers determined within the computing infrastructure of the cloud environment.

After using the unique identifier to determine the object name for the object, the workload deployment component 108 may use the object name to identify a corresponding object in the production environment 116. For instance, the workload deployment component 108 may issue a similar request (e.g., via an API or database query) to access the object listings of the production environment 116, and to determine an object having the same (or similar) object name as the object in the test environment 114. When the matching object is determined using the object listings/object data of the production environment 116, the workload deployment component 108 may use similar techniques to those described above (e.g., API request, database query) to retrieve the unique identifier for the matching object in the production environment 116.

In some examples, the workload deployment component 108 may require that an exact object name match be found in the production environment 116 to the object in the test environment 114. In such examples, when an object with an exact name match is not found in the production environment 116, the workload deployment component 108 either may automatically terminate the deployment request, or may initiate a user interface on the operator device 104 to allow the user to select the matching object in the production environment 116.

In other examples, the workload deployment component 108 might not require an exact object name match in the production environment 116, to determine that an object is a corresponding object to the referenced object in the test environment 114. For instance, the workload deployment component 108 may determine a closest matching object name and/or partial object name matches, using regex and/or pattern matching techniques. Additional techniques for non-exact object name matching may include matching or filtering the object listings based on additional attributes of the object, such as the object type (e.g., queue, prompt, flow, etc.), the time the object was created or last updated, and/or based on the other objects and/or deployments the object interacts within the source environment. By analyzing and/or ranking near-miss name matches, partial name matches, and/or the other object attributes described above, the workload deployment component 108 may determine an object to be a matching object even when the object name is not an exact match to the object in the test environment 114. In some examples, the workload deployment component 108 may determine a subset of possible matching objects based on partial name matching and/or matching object attributes, etc. The subset of possible matching objects may be ranked and/or provided to the user of the operator device 104 via a user interface, thereby allowing the user to more quickly review the subset and select the matching object, rather than having to review and scroll through the entire object listing for the destination environment.

As shown in this example, the workload deployment component 108 may use a separate workload data repository 120, external to the computing environments 114-116, to perform some or all of the object matching between source and destination environments. Similar or identical to the user data repository 118, the workload data repository 120 may be associated with the workload deployment system 102 (e.g., implemented either within or external to the workload deployment system 102) but may be separate from any cloud-based computing environments associated with the workload deployment system 102. For instance, the workload data repository 120 may store tables associating each object in each computing environment used by the organization (e.g., a cloud, cloud account, and/or other computing infrastructure) with another object in another computing environment used by the organization. In some examples, the workload deployment component 108 may use the workload data repository 120 to determine the matching objects across the computing environments used by the organization without needing to access any of the cloud providers or remote cloud-based computing environments. In some instances, the workload data repository 120 may store object name information (e.g., associations between object names in different environments) but might not store the unique identifiers, in which case the workload deployment component 108 may request and retrieve the unique identifiers from the environments 114-116. In still other examples, the workload data repository 120 may be optional, and the workload deployment component 108 may access the source and destination environments (and/or cloud providers) to perform all of the required operations to determine matching object names and retrieve the unique identifiers for the matching objects.

As noted above, after the workload deployment component 108 determines a corresponding (or matching) object within a destination environment (e.g., production environment 116) for an object within the source environment (e.g., test environment 114) that the workload 112 interacts with, the workload deployment component 108 may determine the unique identifier for the matching object and replace the unique identifier in the workload 112 with the unique identifier of the matching object in the destination environment. The unique identifier can be retrieved from the object listings of the destination environment, the cloud provider, and/or from a separate data source (e.g., workload data repository 120).

The technique described above for determining a matching object in a destination environment, retrieving the unique identifier for the matching object, and replacing the previous object unique identifier in the workload with the unique identifier for the matching object, can be performed by the workload deployment component 108 for each unique identifier in the workload referencing an object in the source environment. In some examples, the replacements of the unique identifiers from the source environment object identifiers to the destination environment object identifiers may be done during the deployment process, so that the existing workload in the source environment is not affected. In various examples, the workload deployment component 108 may search the workload in a loop during the deployment process or may perform the unique identifier replacements in parallel as a batch. If every unique identifier replacement performed by the workload deployment component 108 is successful, then the workload deployment system 102 may proceed to perform the deployment using the cloud provisioning component 110, as described below. However, if one or more of the unique identifier replacements is not successful, the workload deployment system 102 may either terminate the deployment request and/or initiate a user interface to allow the user of the operator device 104 to manually determine the matching objects and perform the unique identifier replacements for any replacements that could not be performed automatically.

Additionally, in some examples, during the deployment process the workload deployment system 102 may provide an optional user interface to allow the user of the operator device 104 to perform additional search and replacement operations between the workload deployed in the source environment and the workload deployed in the destination environment(s). For instance, specific text (e.g., words, phrases, etc.) within a contact center workload 112 may be modified between the test environment 114 and the production environment 116, and/or may be modified between different production environments (e.g., an active and inactive production environment, production environments serving different geographic regions, etc.).

After the access verification component 106 verifies that the deployment request may be performed for the selected workload(s), from the source environment to the selected destination environment(s), and after the workload deployment component 108 successfully determines all of the matching objects and replacement unique identifiers within the destination environment(s), then the workload deployment system 102 may proceed to perform the deployment with the cloud provisioning component 110. To perform the requested deployment of the contact center workload 112 into the destination environment (e.g., production environment 116), the cloud provisioning component 110 may determine and execute cloud provisioning instructions to be transmitted to the appropriate cloud service provider 124. As noted above, in some examples, workload provisioning instructions may include executable code that can be executed directly by the cloud provisioning component 110. For example, the cloud provisioning component 110 may include infrastructure as code software instructions using a declarative configuration language in a structured format. To modify and/or generate the workloads in the destination environment, the cloud provisioning component 110 may use languages including one or more of Terraform® by Hashicorp®, Cloudformation® by AWS®, Azure Resource Manager® by Microsoft Azure®, Cloud Deployment Manager® by Google®, Oracle Orchestration Cloud® by Oracle®, or Ansible® by Redhat®. It can be understood from this disclosure that these structured format languages are non-limiting examples only, and that any other domain-specific language for provisioning cloud deployments may be used in other examples.

In some examples, the workload deployment system 102 may execute as an automation pipeline, such as a continuous integration and continuous deployment (CI/CD) pipeline (or a portion of a CI/CD pipeline). In such examples, cloud provisioning component 110 may execute as a containerized application within the CI/CD pipeline, configured to perform the modification of the workload (e.g., replacement of unique identifiers) and to provision the workload into the destination environment(s). For example, the workload deployment system 102 may trigger a CI/CD pipeline to initiate provisioning of the workload into a destination cloud environment, or multiple destination cloud environments, including simultaneously replacing the unique identifiers used in the source environment with the corresponding unique identifiers determined by the workload deployment component 108 for each of the destination environments. In some cases, cloud provisioning component 110 may be integrated natively into a version control system, and may be configured to execute a predetermined execution sequence to deploy the workloads. Additionally, in some cases the workload deployment system 102 may execute multiple automation pipelines in parallel, where each pipeline is associated with different cloud computing environment, corresponding to a different cloud account or other computing infrastructure. In such examples, the multiple pipelines may be executed in parallel to deploy the workload into different cloud-based environments associated with the organization, including different environments for research, test, and production, different active/inactive production environments, etc., at the same time. In some examples, the cloud provisioning component 110 may leverage a clustering solution, in which a single pipeline (or multiple pipelines) may use different computing devices to perform the cloud provisioning instructions of different templates.

As illustrated by the features and examples in this disclosure, the techniques described herein provide technical advantages that improve the capabilities and functioning of systems configured to generate, deploy, and provision software in cloud-based computing environments. In particular, techniques described herein provide advantages for modifying contact center workloads, such as contact flows, for improved security, speed, and accuracy when performing automated deployments of the workloads across cloud computing environments. In contrast to conventional workload deployment techniques, the techniques described herein remove the time-consuming and error-prone manual steps in which a deployment engineer must identify corresponding objects (e.g., queues, prompts, flows, bots, etc.) in different test and production environments. The automation pipeline described herein, implemented using the workload deployment system 102, determines the corresponding objects more quickly and more accurately via object name matching, and performs the unique identifier replacements automatically during the deployment of the workload into the destination environment(s).

In the example computing system 100, the workload deployment system 102 is depicted as being implemented outside of and separate from the cloud computing environments 114 and 116. However, in other examples, the workload deployment system 102 may be implemented within any of the source environments (e.g., test environment 114) and/or destination environments (e.g., production environment 116) associated with the organization. As noted above, the individual source and/or destination environments described herein may include, for example, public clouds, private clouds, and/or hybrid clouds, and/or containers (e.g., accounts) implemented within any of these types of clouds. Additionally or alternatively, a source and/or destination environment may include a non-cloud computing infrastructure such as a datacenter operating in a secure network/facility of the organization.

The techniques described herein thus may be used to perform deployments of executable software workloads between any number/type of different computing environments, including different containers (e.g., accounts) associated with the organization within the same cloud, and/or between different clouds managed by the same or different cloud providers. These techniques also may be applied to deploy workloads from on-premise computing infrastructures (e.g., servers within a datacenter of the organization) to cloud-based environments, and vice versa.

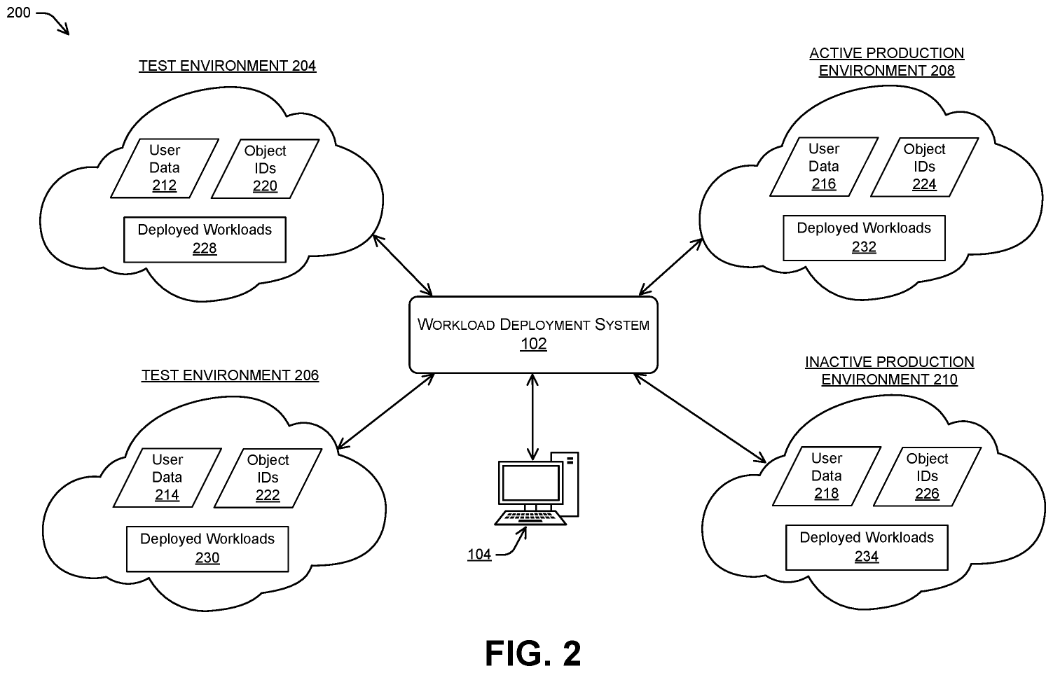

Although only two cloud-based environments are shown in the example computing system 100, in other examples, the techniques described herein can be used to deploy executable software workloads from any number of source environments to any number of destination environments. For example, FIG. 2 shows another example computing environment 200 in which the workload deployment system 102 may be used. In this example, an organization maintains a first test environment 204, a second test environment 206, an active production environment 208, and a separate inactive production environment 210. As noted above, different computing environments, even those implemented within the same cloud or computing infrastructure, may have different sets of authorized users, different security features, different types of access credentials, and/or different access permissions for their respective users. For instance, an individual user within an organization (e.g., a software development engineer, test engineer, deployment engineer, admin, etc.) may have access to one test environment 204 but not to another test environment 206. Another user within the organization may have one level of access to the test environment 206, a different level of access (e.g., greater/lesser) to the active production environment 208, and another different level of access to the inactive production environment 210, and so on. As shown in this example, each separate computing environment 204-210 may maintain a separate set of user data 212-218, securely stored in the computing infrastructure of the environment, including the sets of authorized users, user names/identifiers, and the various object and/or resource permissions, preferences, and the like, for each user.

Further, each separate computing environment 204-210 may store a separate object data repository 220-226 (or object listing), including object names, unique identifiers, and/or user access permissions associated with each object or resource in the respective computing environment 204-210. Additionally, as shown in this example, each separate computing environment 204-210 may include one or more deployed workloads 228-234. The deployed workloads 228-234 may include any software capable of deployment and execution within the computing environments 204-210. In the context of cloud-based computing environments used to implement contact centers, the deployed workloads 228-234 may include contact flows, contact routing workloads, contact tracking and analytics workloads, etc. However, in other examples, the workload deployment system 102 and other computing environments 204-210 need not be limited to contact flows or contact center environments, but may be used to deploy any other type of workload between the separate computing environments associated with an organization.

Certain examples described herein relate to deploying workloads from a software development and/or test environment 204 or 206 into a production environment (e.g., active production environment 208 or inactive production environment 210). However, similar or identical techniques can be used in other examples to deploy workloads from a production environment to a test environment, or to deploy workloads from one production environment to another, or from one test environment to another.

As noted above, various examples herein are described in terms of deploying contact flows of a contact center between cloud-based environments. As used herein, a contact flow may refer to a software object that defines a customer experience when the customer initiates contact with (or is contacted by) the contact center systems, using any of the various communication channels/media types supported by the contact center (e.g., voice, video, chat, social media, text, etc.). In such examples, the contact flow may determine the customer experience from the start of the connection/interaction to the end. For example, for voice interactions with customers, contact flows may be implemented as customized IVR (interactive voice response) systems. For voice, video, chat, or other types of sessions, contact flows may determine the information provided to the customer, the menu options presented, and the queues to which the customer may be routed (if necessary) to interact with an agent. Contact flows may be dynamic and customizable by the organization, based on factors such as the communication channel (e.g., media type), the particular input channel by which the customer accessed the contact center (e.g., phone number dialed, link clicked, email address emailed, etc.), as well as additional factors such as time, geographic region, etc.

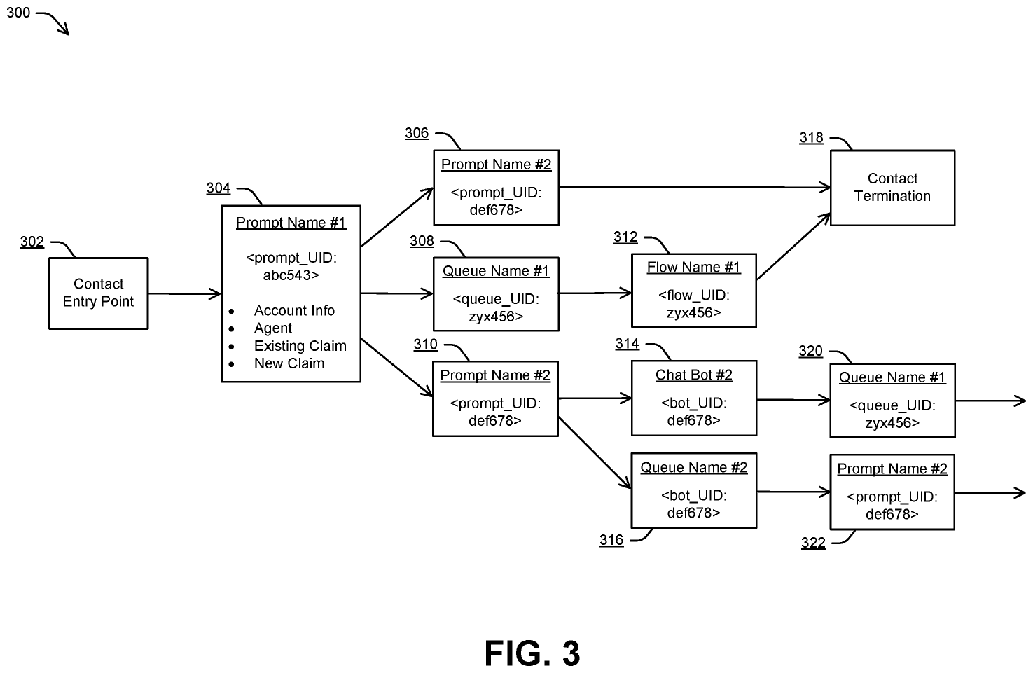

FIG. 3 illustrates an example contact flow object that may be deployed within a computing environment using the various techniques described herein. In this example, the contact flow 300 includes a number of blocks defining the customer experience actions to be taken by the contact center deployment. For example, block 302 represents a customer entry point for the contact flow. Blocks 304, 306, 310, and 322 represent prompts, each having a prompt name and unique identifier that identifies the corresponding prompt object within the computing environment. Prompts may include, for example, music and/or a repeating script to be read to the customer while on hold, and/or may include menu options for the customer to select, or prompts for the customer to input information. Blocks 308, 316, and 320 represent queues, each having a queue name and unique identifier that identifies the corresponding queue object within the computing environment. Block 312 represents a flow within the contact flow 300, which may be referred to as a sub-flow (e.g., a whisper flow), including a flow name and unique identifier for the sub-flow within the computing environment. Block 314 represents a chat bot object including a name and unique identifier for the chat bot within the computing environment. Block 318 represents a contact termination for the contact flow.

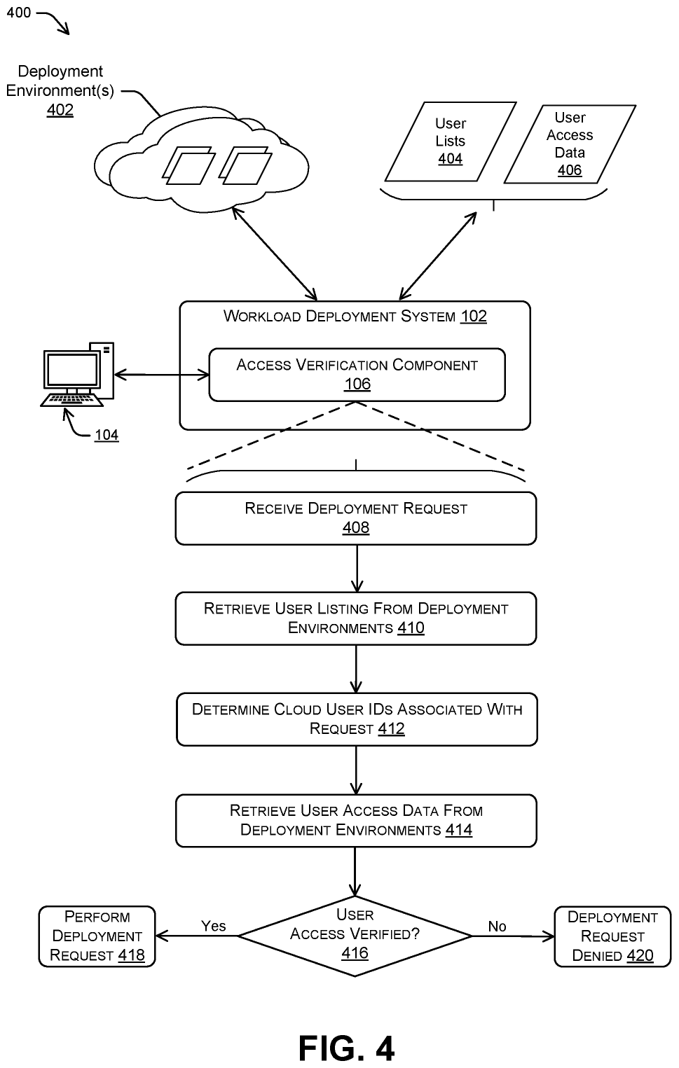

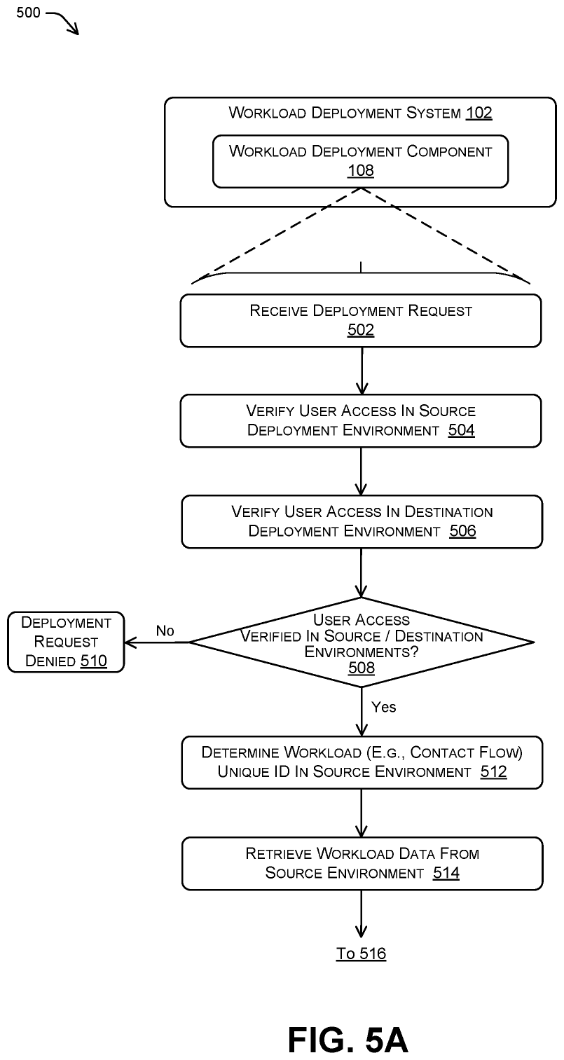

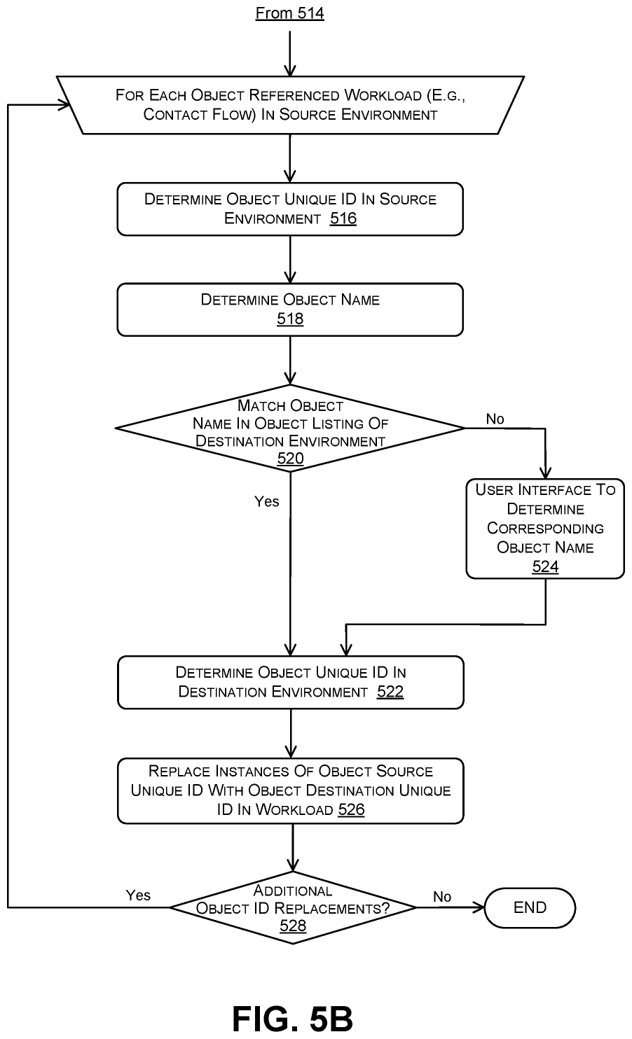

FIG. 4 is a flow diagram illustrating an example process 400 of performing user access verification on one or more source computing environments and destination computing environments. In various examples, process 400 may be performed by an access verification component 106 of a workload deployment system 102, including or in combination with any of the various components described above in FIGS. 1-3. As described below, the process 400 may be initiated in response to receiving a workload deployment request from an operator device 104. Prior to performing the various operations to complete the deployment, discussed below in reference to FIGS. 5A-5B, process 400 may be executed to verify quickly and accurately that the user and/or device that initiated the request is authorized to access the workload on the source environment and to deploy/modify the workload on the destination environment(s).

As described below, during process 400, the access verification component 106 may verify the appropriate user access on the source and destination environments based on user list data 404 and user access data 406. In various examples, the user list data 404 and user access data 406 may represent tables, listings, or other data stores within a user data repository 118, which may be retrieved and written to by the access verification component 106 using database queries and other data store retrieval techniques. Additionally or alternatively, the user lists data 404 and user access data 406 may represent the user access data stored by the individual computing environments, including listings of authorized users, user access permissions for various containers, objects, resources, etc., for each computing environment, which can be retrieved by the access verification component 106 using database queries, API calls, etc.

At operation 408, the access verification component 106 may receive a workload deployment request from a user associated with the organization (e.g., a deployment engineer) via an operator device 104. In various examples, the request may include data identifying a workload in the source computing environment, and the destination environment(s) into which the workload is to be deployed. As discussed above, in some examples the workload may be a contact flow in a contact center test cloud environment, and the destination environment may include one or more production cloud environments of the contact center.

At operation 410, the access verification component 106 may retrieve the user listings associated with one or more of the deployment environments associated with the request. In some examples, the access verification component 106 may determine the user associated with the request, based on a user identifier and/or user credential data received from the operator device 104 prior to or concurrently with the workload deployment request. In some instances, if the workload deployment request and/or the operator device 104 is not associated with a particular user of the organization, the access verification component 106 may initiate a user interface on the operator device 104 to prompt the user from a user identifier and/or credentials. The user listings retrieved in operation 410 may be retrieved from the user lists 404, which may include, for example, listings retrieved from the individual computing environments associated with the request (e.g., via API calls or database queries), and/or listings retrieved from a separate data source (e.g., user data repository 118).

At operation 412, the access verification component 106 may determine a cloud user identifier for each deployment environment associated with the request (e.g., a source computing environment and one or more destination computing environments). For example, the access verification component 106 may match the user information (e.g., user name, user identifier, credentials, etc.) received in association with the request from the operator device 104, to a cloud user identifier in the user listings associated with each of the various deployment environments. In some instances, operation 412 may include matching the organization user ID associated with the request to one or more cloud IDs retrieved from the user lists 404, which may be retrieved from the individual computing environments (e.g., via API calls or database queries), and/or from a separate data source (e.g., user data repository 118).

At operation 414, the access verification component 106 may retrieve user access data associated with the various deployment environments, to determine if the user that initiated the request has the appropriate access permissions to perform the requested workload deployment. For example, for each of the deployment environments associated with the request (e.g., source and destination computing environments), the access verification component 106 may use the cloud ID determined for the environment in operation 412, to retrieve the associated user access permissions that the cloud ID has within the environment. In some instances, operation 414 may include retrieving the user access permissions for the workload and/or other objects in the environment, based on the cloud ID, from the user access data 406, which may be retrieved from the individual computing environments (e.g., via API calls or database queries), and/or from a separate data source (e.g., user data repository 118).

At operation 416, the access verification component 106 may verify whether or not the user has the required access permissions on each of the computing environments to perform the requested workload deployment. For example, the access verification component 106 may determine in operation 416 if the user associated with the request is authorized to access the workload in the source environment, and also if the user is authorized to deploy and/or modify the workload in each of the destination environments. When the access verification component 106 determines that the user does have the required access permissions in the various deployment environments (416:Yes), then at operation 418 the access verification component 106 may allow the deployment request to proceed. For example, the access verification component 106 may provide a response to one or more other components within the workload deployment system 102 confirming the user access permissions for the request, and allowing the additional components to commence the workload deployment operations.

In contrast, when the access verification component 106 determines that the user does not have the required access permissions in one or more of the deployment environments (416:No), then at operation 420 the access verification component 106 may deny and/or prevent the workload deployment from proceeding. In some examples, the access verification component 106 may provide a response to the workload deployment system 102 causing the system to terminate the workload deployment request. In other examples, the access verification component 106 may initiate a user interface on the operator device 104 to request additional authorization credentials from the user, and/or may transmit a notification or other communication to another device (e.g., a deployment admin system) to request approval for the deployment and/or to request that the credentials for the user be elevated to allow the user to perform the deployment.

FIGS. 5A and 5B include another flow diagram illustrating an example process 500 of modifying and deploying a workload within one or more destination computing environments in response to a deployment request received by a workload deployment system. In various examples, process 500 may be performed by a workload deployment component 108 and/or a cloud provisioning component 110 of a workload deployment system 102, including or in combination with any of the various components described above in FIGS. 1-3. As described below, the process 500 may be initiated in response to receiving a workload deployment request from an operator device 104, and/or in response to verifying user access permissions in each source and destination computing environment to perform the deployment. After performing the operations described above in process 400 to verify that the user and/or operator device associated with the request are authorized to access the workload on the source environment and to deploy/modify the workload on the destination environment(s), the operations in process 500 may be executed to perform the deployment via an automated pipeline.

As described below, during process 500, the workload deployment component 108 may retrieve object names and/or unique identifiers for objects and/or resources within the various source and destination environments associated with the workload deployment request. In various examples, the object names and/or unique identifiers for the various objects may be retrieved via the requests (e.g., API calls, database queries, etc.) made to the various computing environments. Additionally or alternatively, the workload deployment component 108 may retrieve the object names and/or unique identifiers for the relevant objects from a separate data store (e.g., workload data repository 120) storing combined object name/identifier data for the various objects and environments associated with the organization.

As shown in FIG. 5A, at operation 502, the workload deployment system 102 may receive a workload deployment request from an organization user (e.g., a deployment engineer) via an operator device 104. Operation 502 may be similar or identical to operation 408 described above. At operation 504, the workload deployment system 102 may verify that the user associated with the workload deployment request has the appropriate access within the source deployment environment (e.g., test environment 114). Additionally, at operation 506, the workload deployment system 102 may verify that the user associated with the workload deployment request has the appropriate access within the one or more destination deployment environments (e.g., production environment 116). In this example, operations 504 and 506 may correspond to one or more executions of process 400, described above.

At operation 508, the workload deployment system 102 may verify the user access for each of the source and destination computing environments required to perform the workload deployment request. As described above in process 400, if the workload deployment system 102 determines that the user associated with the request does not have the required access permissions in one or more of the deployment environments (508:No), then at operation 510 the workload deployment system 102 may deny and/or prevent the requested workload deployment from proceeding. For instance, the workload deployment system 102 may terminate and return a failure in response to the deployment request received in operation 502. Additionally or alternatively, workload deployment system 102 may initiate one or more user interfaces and/or notifications, as described above in process 400, to attempt to obtain the required user access permissions and/or elevate the permissions of the requesting user.

If and when the workload deployment system 102 determines that the user associated with the request has the required access permissions for each of the deployment environments required by the request (508:Yes), then at operation 512 the workload deployment component 108 may determine the unique identifier of the workload in the source environment. In various examples, the workload deployment component 108 may receive the unique identifier of the workload in the workload deployment request, or may retrieve the unique identifier of the workload via an API call, database request, etc., from the source environment or a separate workload data repository.

At operation 514, the workload deployment component 108 may retrieve workload data from the source computing environment in which the workload current resides (e.g., test environment 114). The workload data may include the unique identifiers for each object referenced by the workload and/or with which the workload interacts in the source environment. For instance, for a workload 112 that includes a contact flow of a contact center in a test environment 114, the workload data retrieved in operation 514 may include the unique identifiers for the various queues, flows, prompts, chat bots, and/or any other object or resource within the test environment 114 that is used by the contact flow.

As shown in FIG. 5B, operations 516-528 may be performed repeatedly (e.g., sequentially or in parallel) from each object/resource identified in operation 514. As shown in these operations, for each object and/or resource that the workload references or interacts with in the source environment, the workload deployment component 108 may identify and replace the unique identifier for the object within the workload, with the unique identifier of the corresponding object in the destination environment. Further, as discussed above, the loop of operations 516-528 may be performed multiple times when the workload deployment request calls for deployment into multiple destination environments.

At operation 516, the workload deployment component 108 may determine a unique identifier for the object and/or resource that the workload references or interacts with in the source environment. As described above, in various examples the workload deployment component 108 may retrieve the unique identifier for the object from the source computing environment via an API call or database query, or from a separate workload/object data store (e.g., workload data repository 120).

At operation 518, the workload deployment component 108 may determine the object name for the object, based on the unique identifier of the object in the source environment. To determine the object name, the workload deployment component 108 may use the unique identifier for the object determined in operation 516, and may perform an API call or database query to the source environment (or to a workload data repository 120) to determine the object name.

At operation 520, the workload deployment component 108 may attempt to match the object name determined in operation 518 within the object name listing(s) for the destination environment. To perform the matching, the workload deployment component 108 may retrieve the object listing(s) from the destination environment or from a separate data source (e.g., workload data repository 120) storing an object listing for the destination environment. As described above, in some cases the workload deployment component 108 may compare the object name determined in operation 518 to the object name listing for the destination environment to determine if an exact match exists. In other examples, the workload deployment component 108 might not require an exact match, but may use, for instance, a closest matching object name, partial object name matches, and/or other object attributes to determine a matching object in the destination environment.

When an object matching the object name is identified within the destination environment (520:Yes), then in operation 522, the workload deployment component 108 may determine the unique identifier for that object in the destination environment. In various examples, to determine the unique identifier the workload deployment component 108 may retrieve the unique identifier for the object from the destination computing environment via an API call or database query, or from a separate workload/object data store (e.g., workload data repository 120) associated with the destination environment.

In this example, when an object matching the object name cannot be identified within the destination environment (520:No), then in operation 524, the workload deployment component 108 may generate and provide a user interface to the operator device 104 that initiated the request. As described above, the user interface may include a listing of object names (and/or object attributes), to allow the user to select a corresponding object in the destination environment to match the object in the source environment. In some cases, the workload deployment component 108 may perform filtering and data analysis to determine a subset of possible matching objects based on partial name matching and/or matching object attributes, etc. The subset of possible matching objects may be ranked and/or provided to the user of the operator device 104 via the user interface in operation 524, to allow the user to more quickly review the subset and select the matching object, rather than having to review and scroll through the entire object listing for the destination environment. Although this example includes using a user interface to allow a user to select corresponding/matching objects, in other examples the workload deployment component 108 may be configured to automatically deny the deployment request (e.g., without initiating a user interface) when a matching object name cannot be identified within the destination environment (520:No).

At operation 526, the workload deployment system 102 may replace instances of the unique identifier for the object in the source environment with the updated unique identifier for the corresponding object in the destination environment. As described above, in some instances the replacement may be made during and/or after the deployment into the destination environment by the cloud provisioning component 110. For instance, by replacing the unique identifiers from the source environment object identifiers with the destination environment object identifiers during the deployment process, the existing workload in the source environment need not be affected.

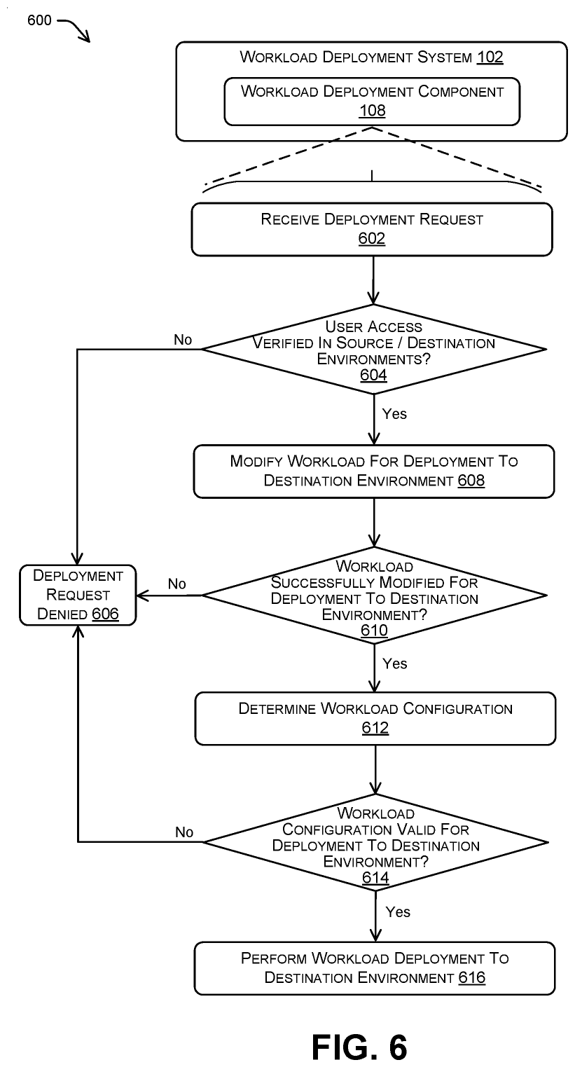

FIG. 6 depicts another flow diagram illustrating an example process 600 of validating a workload configuration and deploying the workload in a destination computing environment, in response to a deployment request received by a workload deployment system. As in the previous example, process 600 may be performed by a workload deployment component 108 and/or a cloud provisioning component 110 of a workload deployment system 102, including or in combination with any of the various components described above in FIGS. 1-3. The process 600 also may be initiated in response to receiving a workload deployment request from an operator device 104, and/or in response to verifying user access permissions in each source and destination computing environment to perform the deployment. As described below in more detail, in some examples process 600 may incorporate one or both of process 400 and process 500 described above. For example, after performing the operations described above in process 400 (e.g., to verify that the user and/or operator device associated with the request are authorized to access the workload on the source environment and to deploy/modify the workload on the destination environment(s)), and/or performing the operations in process 500 (e.g., to modify the workload for deployment into the particular destination environment(s)), the operations of process 600 may be performed to determine and validate the configuration of the workload, and then to deploy the workload into the destination environment(s).

As described below, during process 600, the workload deployment component 108 (and/or the cloud provisioning component 110) may be configured to validate one or more configuration settings of a workload before it is deployed into a destination environment. For example, the configuration of a contact flow object may be validated to confirm that specific configuration settings and/or behaviors of the contact flow are compatible with the requirements of the destination environment. In some instances, different configuration settings may be used in test environments and production environments, and in other instances configuration settings that are not set (or set improperly) might not have a detrimental effect when running in a test environment, but may potentially have a detrimental effect within a production environment. Therefore, certain examples of process 600 may include validating the configuration of contact flow workloads before their deployment from test environments into production environments, although these techniques may be used to validate the configurations of any different type of workload described herein, to and/or from any different type of computing environment described herein.

At operation 602, the workload deployment system 102 may receive a workload deployment request from an organization user (e.g., a deployment engineer) via an operator device 104. Operation 602 may be similar or identical to operation 502 and/or operation 408 described above.

At operation 604, the workload deployment system 102 may verify that the user associated with the workload deployment request has the appropriate access within the source deployment environment (e.g., test environment 114) and within the destination deployment environment(s) (e.g., production environment 116). In this example, operations 604 may be similar or identical to operations 504-508 described above.

If the workload deployment system 102 determines that the user associated with the request does not have the required access permissions in one or more of the destination environments (604:No), then at operation 606 the workload deployment system 102 may deny and/or prevent the requested workload deployment from proceeding. For instance, the workload deployment system 102 may terminate and return a failure in response to the deployment request received in operation 602. Additionally or alternatively, workload deployment system 102 may initiate one or more user interfaces and/or notifications, as described above in process 400, to attempt to obtain the required user access permissions and/or elevate the permissions of the requesting user.

In contrast, if the workload deployment system 102 determines that the user associated with the request has the required access permissions for each of the destination environments (which also may be referred to as deployment environments) required by the request (604:Yes), then at operation 608 the workload deployment component 108 may modify the workload for deployment to the destination environment(s). In various examples, operation 608 may be similar or identical to operations 512-528 described above, during which the workload may be modified for deployment into one or more particular destination environments using the techniques described herein.

At operation 610, the workload deployment system 102 may verify that the workload has been successfully modified for deployment to the intended destination environments. As described above, in some instances the automation pipeline may fail to successfully modify a workload for deployment to a destination environment (610:No). Such instances may include failing to determine a matching or corresponding object name in operations 520 and/or 524 (or failing to determine the object name with a sufficiently high likelihood threshold). In these instances, when the workload cannot be successfully modified for deployment using the automation pipeline and/or associated manual operations and/or user interfaces (610:No), then at operation 606 the workload deployment system 102 may deny and/or prevent the requested workload deployment from proceeding. However, when the workload is successfully modified for deployment using the automation pipeline and/or associated manual operations and/or user interfaces (610:Yes), then at operation 612 the workload deployment component 108 may determine a workload configuration for the modified workload.

At operation 612, the workload deployment component 108 may identify and/or retrieve any number of workload configuration features and/or settings of the workload to be deployed based on the deployment request. As an example, a redaction setting may be set (e.g., either on or off) for a contact flow object. When the redaction setting is set to on, the contact flow object may be controlled within its deployment environment to redact any sensitive or confidential data (e.g., personal customer data) when the contact flow is used to generate transcripts. In some examples, deployment to a production environment may require that the configuration redaction setting be set to on.

Other examples of configuration settings that may be stored and set for various workloads may include language preference settings (e.g., English, Spanish, France, etc.), settings indicating that a contact flow is an entry flow (e.g., associated with a specific phone number that when dialed with invoke the contact flow). Additional configuration settings for contact flows and/or various other objects described herein can include metadata attributes such as intent (e.g., representing a reason for the customer call/contact). A metadata attribute of a contact flow or other workload object may have a particular attribute and datatype, and in some examples, deployment to a production environment may require that the name (and/or data type) of the metadata attribute is set to a predetermined standard/uniform name (and/or data type) so that the when the metadata is stored for instances of the workload object it can be used for downstream analytics. Although these examples refer to a number of specific configuration settings (e.g., a redaction setting, a language setting, an entry flow and/or associated phone number setting, attribute names, etc.), these specific configuration settings are illustrative only. In other examples, any number of other configuration settings may be determined in operation 612 and/or validated in operation 614, including configuration settings associated with specific objects within a workload (e.g., contact flow objects, queue objects, prompt objects, etc.) and/or configuration settings associated with the workload as a whole.

At operation 614, the workload deployment component 108 may validate the configuration for the workload objects (e.g., contact flows, prompts, queues, etc.) determined in operation 612. Validating the configuration may include comparing the configuration settings associated with the workload objects to predetermined sets of required (or preferred) configuration settings before the workload can be deployed to the destination environment. As noted above, one example may include validating that a redaction setting is set to on before deploying a workload to a production environment. Another example may include validating a language setting of an object, and/or validating a phone number associated with a contact flow. In various examples, the configuration validation performed in operation 614 may include validating single configuration settings, or may include validating a combination of settings to confirm that the combination represents a valid configuration for the deployment environment. For example, a first language setting may require the redaction setting to be turned on, but a second language setting might not require the redaction setting to be on.

In some examples, the configuration validation performed in operation 614 may be performed based on sets of predetermined validation rules maintained by the workload deployment component 108. The validation rules may be universal in some examples and may be applied to all workload deployments performed by the workload deployment system 102. Additionally or alternatively, different sets of configuration validation rules used in operation 614, based on the source computing environment, destination computing environment, and/or the user that requested the deployment in operation 602. For instance, one set of configuration validation rules may be used for deployments into a first production environment, while a second different set of configuration validation rules may be used for deployments into a second environment (e.g., a different production environment or a test environment). Additionally, different sets of configuration validation rules may be applied when different authorized users request a deployment of a workload, etc.

In this example, when the workload deployment system 102 determines that the configuration of the workload cannot be validated as being compatible with (or acceptable to) the destination environment (614:No), then at operation 606 the workload deployment system 102 may deny and/or prevent the requested workload deployment from proceeding. However, in other examples, in response to a failed validation in operation 614, the workload deployment component 108 may be configured to automatically reconfigure the workload to make it compatible with the configuration requirements of the destination environment.

In contrast, when the workload deployment system 102 determines that the configuration of the workload is valid for deployment to the destination environment (614:Yes), then at operation 616 the workload deployment system 102 may proceed to perform the workload deployment into the destination environment 616. As described above, in some examples, the workload deployment system 102 may use a cloud provisioning component 110 may determine and execute cloud provisioning instructions to the cloud service providers of the source computing environment and the destination computing environment to perform the workload deployment.

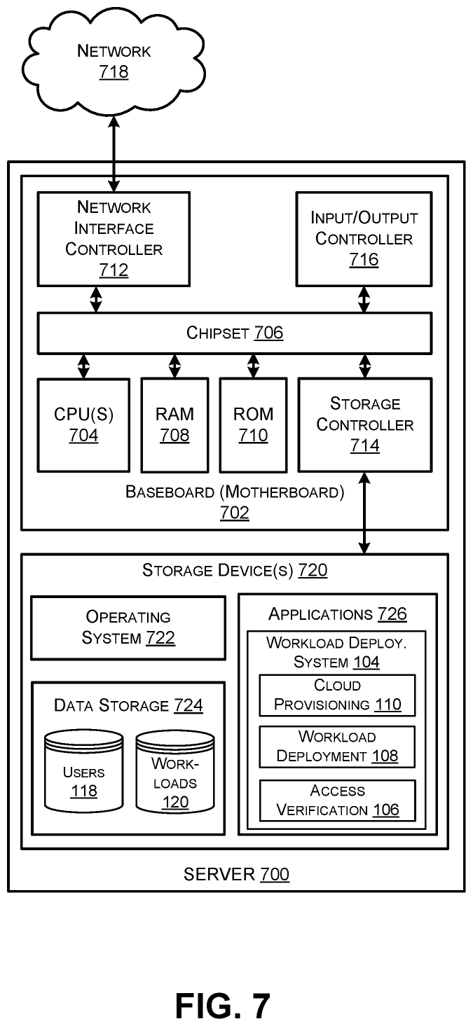

FIG. 7 shows an example architecture of a computer server 700 capable of executing program components for implementing the various functionality described herein. Although the computer architecture in this example is labeled as a server, it can be understood from this disclosure that similar or identical computer architectures may be implemented via workstations, desktop or laptop computers, tablet computers, network appliances, mobile devices (e.g., smartphones, etc.) or other computing device, and/or virtual machines or cloud-based computing solutions, any or all of which may execute any combination of the software components described herein. The server 700 may, in some examples, correspond to any of the computing systems or devices described above, such as a workload deployment system 102, the operator device 104, one or more of the cloud service providers, and/or any other computing devices, systems, or components executing the software components described herein. It will be appreciated that in various examples described herein, a server 700 might not include all of the components shown in FIG. 7, may include additional components that are not explicitly shown in FIG. 7, and/or may utilize a different architecture from that shown in FIG. 7.

The server 700 includes a baseboard 702, or “motherboard,” which may be a printed circuit board to which a multitude of components or devices are connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the server 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the server 700. The chipset 706 can further provide an interface to a computer-readable storage medium such as a ROM 710 or non-volatile RAM (“NVRAM”) for storing basic routines that help to startup the server 700 and to transfer information between the various components and devices. The ROM 710 or NVRAM can also store other software components necessary for the operation of the server 700 in accordance with the configurations described herein.

The server 700 can operate in a networked environment using logical connections to remote computing devices and computer systems through a network, such as the network 718, which may be similar or identical to any of the communication networks discussed above. The chipset 706 also may include functionality for providing network connectivity through a Network Interface Controller (NIC) 712, such as a gigabit Ethernet adapter. The NIC 712 is capable of connecting the server 700 to other computing devices (e.g., operator devices 104, cloud service providers, etc.) over the network 718. It should be appreciated that multiple NICs 712 can be present in the server 700, connecting the computer to other types of networks and remote computer systems. In some instances, the NICs 712 may include at least on ingress port and/or at least one egress port.

The server 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device.

The server 700 can include one or more storage device(s) 720, which may be connected to and/or integrated within the server 700, that provide non-volatile storage for the server 700. The storage device(s) 720 can store an operating system 722, data storage systems 724, and/or applications 726, which are described in more detail herein. The storage device(s) 720 can be connected to the server 700 through a storage controller 714 connected to the chipset 706. The storage device(s) 720 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server 700 can store data on the storage device(s) 720 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 720 are characterized as primary or secondary storage, and the like.

For example, the server 700 can store information to the storage device(s) 720 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server 700 can further read information from the storage device(s) 720 by detecting the physical states or characteristics of one or more particular locations within the physical storage units.

In addition to the storage device(s) 720 described above, the server 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the server 700. In some examples, the various operations performed by the computing systems described herein (e.g., access verification component 106, workload deployment component 108, cloud provisioning component 110, etc.) may be implemented within a datacenter including one or more servers or devices similar to server 700. For instance, some or all of the operations described herein may be performed by one or more server 700 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 720 can store an operating system 722 utilized to control the operation of the server 700. In some examples, the operating system 722 comprises a LINUX operating system. In other examples, the operating system 722 comprises a WINDOWS® SERVER operating system from MICROSOFT Corporation of Redmond, Washington. In further examples, the operating system 722 can comprise a UNIX operating system or one of its variants. It should be appreciated that other operating systems can also be utilized. The storage device(s) 720 can store other system or application programs and data utilized by the server 700.

In various examples, the storage device(s) 720 or other computer-readable storage media is encoded with computer-executable instructions which, when loaded into the server 700, transform the computer from a general-purpose computing system into a special-purpose computer capable of implementing various techniques described herein. These computer-executable instructions transform the server 700 by specifying how the CPUs 704 transition between states, as described above. In some examples, the server 700 may have access to computer-readable storage media storing computer-executable instructions which, when executed by the server 700, perform the various techniques described herein. The server 700 can also include computer-readable storage media having instructions stored thereupon for performing any of the other computer-implemented operations described herein.

As illustrated in FIG. 7, the storage device(s) 720 may store one or more data storage systems 724 configured to store data structures and other data objects. In some examples, data storage systems 724 may include one or more data stores, which may be similar or identical to the user data repository 118 and/or the workload repository 120 described above. Additionally, the software applications 726 stored on the server 700 may include one or more client applications, services, and/or other software components. For example, application(s) 726 may include any combination of the components 106-110 of the workload deployment system 102 and/or other software components described above in reference to FIGS. 1-6.

As illustrated by the above examples, the techniques described herein provide technical advantages that improve the capabilities and functioning of systems configured to generate, deploy, and provision software in cloud-based computing environments. In particular, techniques described herein provide advantages for modifying contact center workloads, such as contact flows, for improved security, speed, and accuracy when perform automated deployments of the workloads across cloud computing environments. In contrast to conventional workload deployment techniques, the techniques described herein remove the time-consuming and error-prone manual steps in which a deployment engineer must identify corresponding objects (e.g., queues, prompts, flows, bots, etc.) in different test and production environments. The automation pipeline described herein, implemented using the workload deployment system 102, determines the corresponding objects more quickly and more accurately via object name matching, and performs the unique identifier replacements automatically during the deployment of the workload into the destination environment(s).

As noted above, large organizations may create many different cloud environments for different product development teams, projects, environment types (e.g., production and non-production), and clouds/regions. In these examples, an operator of the organization can use the workload deployment system 102 to quickly deploy workloads between any number of cloud environments, each having different security features, different sets of authorized users, and different access credentials, as well as different object listings and unique object identifiers. Thus, unlike conventional deployment systems, the workload deployment system 102 may supports the deployment of workloads, individually or in large grounds, to any number of cloud-based environments associated with the organization, without requiring the operator to manual search object listings, copy and paste unique identifiers, or otherwise to manually edit infrastructure as code or other provisioning software files.

Further advantages include common workload deployment requests, failover logic, user interfaces and notification schemes, that are cloud-agnostic and cloud service provider-agnostic, for modifying and deploying workloads across cloud environments. In these examples, neither the operator nor the organization is limited to a single cloud service provider, and an operator/organization performing deploys to or from different environments of different cloud service providers to create additional workloads does not require rewriting the workloads themselves or the provisioning code by technical personnel.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving, by a deployment automation pipeline comprising at least one processor, data identifying a contact center workload deployed within a first cloud computing environment, the contact center workload including a plurality of unique identifiers associated with a plurality of objects in the first cloud computing environment;
determining, by the deployment automation pipeline, and based on a first unique identifier of the plurality of unique identifiers, a first object in the first cloud computing environment;
determining, by the deployment automation pipeline, a first name associated with the first object, wherein determining the first name includes determining that the first name is associated with the first unique identifier within a first object listing of the first cloud computing environment;
determining, by the deployment automation pipeline, a second unique identifier associated with a second object in a second cloud computing environment, wherein determining the second unique identifier includes determining that the second unique identifier is associated with the first name within a second object listing of the second cloud computing environment; and
modifying, by the deployment automation pipeline, the contact center workload, wherein modifying the contact center workload includes replacing the first unique identifier with the second unique identifier in the contact center workload.

2. The method of claim 1, further comprising:
deploying the modified contact center workload within the second cloud computing environment.

3. The method of claim 2, further comprising:
validating a configuration setting within the modified contact center workload, wherein deploying the modified contact center workload is based at least in part on validating the configuration setting.

4. The method of claim 1, wherein receiving the data identifying the contact center workload comprises receiving a deployment request via the deployment automation pipeline, and wherein modifying the contact center workload comprises:
determining a user identifier within the first cloud computing environment associated with the deployment request; and
verifying a first level of user access associated with the user identifier to the contact center workload in the first cloud computing environment.

5. The method of claim 4, wherein modifying the contact center workload further comprises:
determining the second cloud computing environment, based on the deployment request; and
verifying a second level of user access associated with the user identifier to the second cloud computing environment.

6. The method of claim 1, wherein the plurality of objects associated with the contact center workload deployed in the first cloud computing environment include at least one of:
at least one queue object;
at least one flow object;
at least one sub-flow object; or
at least one prompt object.

7. The method of claim 1, further comprising:
determining, based on the plurality of unique identifiers within the contact center workload, the plurality of objects in the first cloud computing environment;
determining, for each particular object in the plurality of objects in the first cloud computing environment:
a name associated with the particular object, based on matching a unique identifier associated with the particular object in the first object listing;
a corresponding object in the second cloud computing environment associated with the particular object, based on matching the name to a corresponding name in the second cloud computing environment; and
a unique identifier associated with the corresponding object in the second cloud computing environment, based on matching the corresponding name to a unique identifier in the second object listing.

8. The method of claim 1, wherein determining the second unique identifier comprises:
comparing the first name to a plurality of names in the second object listing of the second cloud computing environment; and
rendering a user interface, in response to determining that the first name does not match a name within the second object listing, the user interface including an object selection component with a plurality of selection options based on the second object listing.

9. The method of claim 1, wherein the first cloud computing environment is a test environment associated with the contact center workload, the method further comprising:
determining, based on receiving the data identifying a contact center workload, a plurality of production environments associated with the test environment, the plurality of production environments including the second cloud computing environment.

10. A computer system, comprising:
one or more processors; and
one or more non-transitory computer-readable media storing computer-executable instructions that, when executed by the one or more processors, cause the one or more processors to perform operations comprising:
receiving a workload deployment request identifying a contact center workload deployed within a source cloud computing environment;
determining a destination cloud computing environment associated with the workload deployment request;
determining a first unique identifier in the contact center workload;
determining a first object name associated with the first unique identifier, wherein determining the first object name includes matching the first unique identifier within a first object listing of the source cloud computing environment;
determining a second unique identifier in the destination cloud computing environment, wherein determining the second unique identifier includes matching the first object name within a second object listing of the destination cloud computing environment; and
modifying the contact center workload for deployment within the destination cloud computing environment, wherein modifying the contact center workload includes replacing the first unique identifier with the second unique identifier in the contact center workload.

11. The computer system of claim 10, the operations further comprising:
validating a configuration setting within the modified contact center workload; and
deploying the modified contact center workload within the destination cloud computing environment, wherein deploying the modified contact center workload is based at least in part on validating the configuration setting.

12. The computer system of claim 10, the operations further comprising:
determining a user identifier within the source cloud computing environment associated with the workload deployment request; and
verifying a first level of user access associated with the user identifier to the contact center workload in the source cloud computing environment.

13. The computer system of claim 12, wherein modifying the contact center workload further comprises:
determining the destination cloud computing environment, based on the workload deployment request; and
verifying a second level of user access associated with the user identifier to the destination cloud computing environment.

14. The computer system of claim 10, wherein the first unique identifier is associated with a first object in the source cloud computing environment, the first object comprising at least one of:
a queue object;
a flow object;
a sub-flow object; or
a prompt object.

15. The computer system of claim 10, wherein determining the second unique identifier comprises:
comparing the first object name to a plurality of object names in the second object listing of the destination cloud computing environment; and
rendering a user interface, in response to determining that the first object name does not match an object name within the second object listing, the user interface including an object selection component with a plurality of selection options based on the second object listing.

16. The computer system of claim 10, wherein determining the destination cloud computing environment associated with the workload deployment request comprises:
determining the source cloud computing environment associated with the contact center workload, wherein the source cloud computing environment is a test environment; and
determining a plurality of production environments associated with the test environment, the plurality of production environments including the destination cloud computing environment.

17. One or more non-transitory computer-readable media storing instructions executable by a processor, wherein the instructions, when executed by the processor, cause the processor to perform operations comprising:
receiving data identifying a contact center workload deployed within a source cloud computing environment;
determining a destination cloud computing environment for the contact center workload;
determining a first unique identifier in the contact center workload, the first unique identifier associated with a first object deployed in the source cloud computing environment;
determining a first object name associated with the first unique identifier, wherein determining the first object name includes matching the first unique identifier within a first object listing of the source cloud computing environment;
determining a second unique identifier associated with a second object in the destination cloud computing environment, wherein determining the second unique identifier includes matching the first object name within a second object listing of the destination cloud computing environment; and
modifying the contact center workload by replacing the first unique identifier with the second unique identifier in the contact center workload.

18. The one or more non-transitory computer-readable media of claim 17, the operations further comprising:
validating a configuration setting within the modified contact center workload; and
deploying the modified contact center workload within the destination cloud computing environment, wherein deploying the modified contact center workload is based at least in part on validating the configuration setting.

19. The one or more non-transitory computer-readable media of claim 17, the operations further comprising:
determining a user identifier within the source cloud computing environment; and
verifying a first level of user access associated with the user identifier to the contact center workload in the source cloud computing environment.

20. The one or more non-transitory computer-readable media of claim 17, wherein determining the second unique identifier comprises:
comparing the first object name to a plurality of object names in the second object listing of the destination cloud computing environment; and
rendering a user interface, in response to determining that the first object name does not match an object name within the second object listing, the user interface including an object selection component with a plurality of selection options based on the second object listing.
